(19) United States
(12) Patent Application Publication
(10) Pub. No.: US 2008/0126116 A1
(43) Pub. Date: May 29, 2008

(54) Method and apparatus for a private information system and service transactions that minimize theft of identity data

(76) Inventor: Tara Chand Singhai, Torrance, CA (US)

Correspondence Address: Tara Chand Singhai, P O Box 5075, Torrance, CA, 90510, US

(21) Appl. No.: 11/982,092

(22) Filed: Oct. 31, 2007

Related U.S. Application Data
(62) Division of application No. 11/152,322, filed on Jun. 10, 2005.
Application No. 11/152,322 is a division of application No. 09/570,232, filed on May 12, 2000, now Pat. No. 6,938,022.

(51) Int. Cl. G06Q 10/00

(52) U.S. Cl. 705/1

(57) ABSTRACT

A method and apparatus (10) for a privacy system (12) that facilitates anonymous service transactions globally between a customer (20) and a service merchant (22) and that minimizes the theft of personally sensitive identity data. The privacy system (12) allows the customer (20) to receive service (60) from the merchant (22) over the Internet without the merchant (22) receiving and keeping the identity data, bankcard information and other personally sensitive Id theft prone data of the customer (20). Invention also discloses a private information system on Internet using an anonymous identifier to store private information that minimizes the theft of personally sensitive identity data. The anonymous identifier is self-created by a person to assure anonymity to the person to facilitate anonymous and secure transactions over the Internet.

### CROSS REFERENCE TO RELATED APPLICATIONS

This application is divisional application of application Ser. No. 11/152,322, filed Jun. 10, 2005, titled, “Method And Apparatus For A Private Information System And Service Transactions That Minimize Theft Of Identity Data”, Examiner Ciristina Owen Sherr, Art Unit 3621, due to claim restriction and election.

The application Ser. No. 11/152,322 is a divisional of original application Ser. No. 09/570,232, which is incorporated herein by reference.

84. A method of protecting Identity theft sensitive personal data-of a customer from a service provider over a global computer network, comprising the steps of:
a. receiving customer personal data over a computer network; the personal data having attributes of (i) an identifying data such as, name, address and identification numbers such as telephone number, social security number and driver license number, and (ii) a non-identifying data specific to a person such as, financial data, tax data, body dimension data, insurance data, and health data;
b. partitioning the customer personal data into the attributes of the customer identifying data and the customer non-identifying data;
c. assigning a non-customer identifying reference to the customer non-identifying data and saving the reference and the customer non-identifying data in a database server.

85. The method of claim 84 further comprising the steps of:
facilitating receiving customer personal data by providing forms that support different types of customer service from a group of, (i) data that supports a loan application, (ii) data that supports a tax computation, (iii) data that supports financial planning, (iv) data that supports custom fitting of wearable articles, (v) data that supports an application for insurance quotes, and (vi) data that supports health care advice.

86. The method of claim 84 further comprising the steps of:
forwarding the reference and the customer non-identifying data to the service provider.

87. The method of claim 84 further comprising the steps of:
a. processing a payment, using existing payment authorization networks, from the customer to the service provider for payment of the service;
b. forwarding payment authorization data to the service provider with the non-customer identifying reference.

88. The method of claim 86 further comprising the steps of:
a. receiving the results of the service from the service provider;
b. associating the results with the customer identifying data.

89. The method of claim 88 further comprising the steps of:
forwarding the results of the service to the customer.

90. The method of claim 89 further comprising the steps of:
processing further the received results from the service provider before forwarding to the customer.

91. The method of claim 88 further comprising the steps of:
forwarding the results of the service to a plurality of third parties selected by the customer.

92. A computer system having a plurality of servers for protecting identity theft sensitive personal data of a customer from a service provider over a global computer network, comprising:
a. a function that receives customer personal data over a computer network; the personal data has attributes of (i) an identifying data part such as, name, address and identification numbers and (ii) a non-identifying data part such as, financial data, tax data, body dimensions data, insurance data and health data;
b. a function that partitions the customer personal data, into the customer identifying data part and customer non-identifying data part;
c. a function that assigns a non-customer identifying reference to the customer non-identifying data and saves the reference and the customer non-identifying data in a database server.

93. The system as in claim 92 further comprising:
a function that facilitates receiving customer personal data by providing forms that support different types of customer service from a group of, (i) data that supports a loan application, (ii) data that supports a tax computation, (iii) data that supports financial planning, (iv) data that supports custom fitting of wearable articles, (v) data that supports an application for insurance quotes, and (vi) data that supports health care advice.

94. The system as in claim 92 further comprising:
a function that enables the customer to select the service provider from a list of service providers and forwards the reference and the customer non-identifying data to the service provider.

95. The system as in 92 further comprising:
a function that processes a payment, from the customer to the service provider for payment of the service, using existing payment authorization networks and forwards payment authorization data to the service provider.

96. The system as in claim 92 further comprising:
a. a function that receives the results of service from the service provider;
b. a function that associates the results with the customer identifying data and forwards the results to the customer.

97. The system as in claim 96 further comprising:
a function that forwards the results of the service to a plurality of third parties selected by the customer.

98. A computer system having a plurality of servers for protecting identity theft sensitive personal data of a customer in an information system comprising:
a. an access function that presents a screen, that requires entry of only one initial sequence of data items from the customer, in lieu of a user id and a password;
b. the initial sequence includes at least three data format items from a group of, (i) zip code, (ii) name initials, (iii) a date, (iv) personal like and dislike phrase, (v) a personal number, (iv) gender, these specific format of data facilitate creation of the sequence by memory association with these known formats;
c. a function that receives the sequence and creates a new customer record in the information system, for anchoring customer personal information, wherein a customer identifying part and a customer non-identifying part of the personal information are saved in separate database servers.

99. The system as in claim 98, comprising:
a. a function that maps the sequence to a unique reference number that is then used for anchoring customer information;
b. the unique reference number is used to anchor customer information from a group of, (i) data that supports a loan application, (ii) data that supports a tax computation, (iii) data that supports financial planning, (iv) data that supports custom fitting of wearable articles, (v) data that supports an application for insurance quotes, (vi) data that supports health care advice, and (vii) data that is used for contacting the customer.

100. The system as in claim 99, comprising:
a. a function that uses the subsequent entry of the sequence for mapping to the unique reference number for then mapping to customer data of the customer;
b. a plurality of functions that support data processing activity such as changing, adding, deleting and retrieval of customer data.
